(19) United States
(12) Patent Application Publication
(10) Pub. No.: US 2013/0289900 A1
(43) Pub. Date: Oct. 31, 2013

(54) Gap Measurement Tool and Method of Use

(71) Applicant: AREVA NP INC., Lynchburg, VA (US)

(72) Inventors: Joseph Robert Wyatt, III, Lynchburg, VA (US); John Carroll Griffith, Lynchburg, VA (US)

(73) Assignee: AREVA NP Inc., Lynchburg, VA (US)

(21) Appl. No.: 13/857,598

(22) Filed: Apr. 5, 2013

Related U.S. Application Data
(60) Provisional application No. 61/638,813, filed on Apr. 26, 2012.

(51) Int. Cl. G01N 29/34

(52) U.S. Cl. CPC G01N 29/348
USPC 702/56; 73/633

(57) ABSTRACT

A process of collecting and manipulating data to measure the gap between structural components of a piece of equipment or a system is disclosed and claimed. The technique uses ultrasonic zero degree longitudinal waveforms to measure the gap. The technique subtracts the average of two adjacent waveforms from the waveform being processed to remove data from reflections from the components to reveal the reflections generated by the gap.

### CROSS-REFERENCE TO RELATED APPLICATIONS

This patent application claims the benefit of U.S. Provisional Patent Application No. 61/638,813 filed on Apr. 26, 2012, which is incorporated herein by reference in its entirety.

### BACKGROUND OF THE INVENTION

1. Field of the Invention

The present invention relates to non-destructive testing, and, more particularly, the present invention relates to a system for measuring the separation distance between two structural components.

2. Description of the Related Art

A nuclear plant steam generator is a large heat exchanger comprised of thousands of upside-down Li-tubes within an outer shell. FIG. 1 illustrates a steam generator. The U-tubes 2 are approximately 16 to 23 mm in diameter and 10 to 25 m long. The tube ends protrude through a thick (approximately 0.6 m) plate that caps a half-spherical plenum at the bottom of the steam generator. This half-spherical plenum is divided into two quarter spherical plenums—one designated as the hot-leg plenum, and the other as the cold-leg plenum. Hot water that has been pumped through the reactor passes into the hot plenum and then through the tube inside diameter (ID) to the cold plenum. This plenum and the tube IDs are referred to as the primary side of the heat exchanger. Primary side pressure is maintained high enough to prevent the water from flashing into steam. The secondary side of the system is comprised of the area within the steam generator shell but on the tube outside diameter or outside diameter (OD). Heat energy passes from the tube primary side (ID side) to the secondary side of the steam generator. Water is pumped into the secondary side shell via a feedwater inlet 4 and header 5 and surrounds the bottom portion of the tubes. As this secondary side water heats, it converts into steam, passes through components 6 to remove moisture, and exits the top of the steam generator via a nozzle 7 to drive the turbine that ultimately drives the electrical generator that produces the electrical power supplied to the grid. Fluid flows in the primary and secondary side can cause the tubes to vibrate. A lattice grid of bars referred to as anti-vibration-bars (AVBs) are incorporated in the steam generator design to limit these vibrations. The separation (gap) between a tube and an adjacent AVB is typically less than 0.0254 mm (0.001 inch) and the exact gap dimension can be critical to controlling tube vibrations. If the vibration is excessive, wear can occur where the tubes contact the AVBs or each other. Examples of such wear are shown in FIG. 2, which shows the AVBs 1 and U-tubes 2 having areas of wear 3.

Inspection of these tubes for wear and other types of degradation is accomplished by inserting an electromagnetic (ET) probe or an ultrasonic (UT) probe into the tubes from either the hot or cold-leg plenum. Either ET or UT probes are connected to the instrument through a flexible polymer tube that protects the wires and is rigid enough to be pushed through the tubes. The probes are forced through the tube with a pinch-wheel pusher-puller mounted just outside the plenum man-way. The pusher-puller can push these probes all the way from one tube-end to the other tube-end connected on each side of the tube sheet. Since the primary side plenums are highly contaminated, people are not normally allowed to be in this area. A guide tube is positioned and aligned to each tube to be inspected by a remotely controlled robot.

The probe is connected to an inspection instrument (either UT or ET) that digitizes the probe signal and sends it to a computer for further processing and analysis. This invention and approach to signal processing must operate within this inspection environment.

Wear of steam generator tubing at its support structures is a significant concern for tube integrity. Although steam generator design and construction are key aspects in preventing or minimizing tube wear, the success has been limited.

For those steam generators that experience wear at support structures, there is a need to accurately measure the gap (separation) between the outer diameter surface of a steam generator tube and its surrounding support structures. More recently, gap measurement has been needed to determine the separation between tubes and their adjacent support structures in the U-bend region of the steam generator. Since, by design, this separation is small (typically less than 0.005 inch), the technique must accurately measure the gap to an accuracy of 0.001 inch or less to be useful in the assessment of the positioning of the tubes relative to their adjacent support structures.

Methods currently available to perform this assessment, such as rotating eddy current, have not been able to achieve the level of accuracy needed to be useful. Current ultrasonic methods use angle beams, either longitudinal or traverse waves in a pitch-catch (two transducer) configuration to produce a single reflection from the tube outer diameter surface and a single reflection from the support structure whose separation in time represents the gap distance. While ideally this method should work, the separation distance between the two transducers, and oftentimes the addition of a mirror, results in a probe length that cannot be used for an examination of the U-bend region. In addition, the variation in the beam angles makes this option almost impossible to implement.

The reflections from the gap between the outer diameter surface of the tube and the support structure have often been observed during ultrasonic zero degree longitudinal wave wall thickness examinations. While the reflections generated by the gap have been useful in identifying the presence of the support structure within the acquired data, the combined reflections from the wall thickness and the gap have made it impossible to evaluate just the gap reflection to determine the separation distance.

The technique described herein removes the reflections generated by the wall thickness thereby revealing the gap reflections, which can then be evaluated to determine the separation between the tube outer diameter surface and the adjacent support structure.

### SUMMARY OF THE INVENTION

The technique of the present invention uses ultrasonic zero degree longitudinal waveforms to measure the gap (separation) between the outer diameter surface of a tube and the adjacent support structure. FIGS. 3 and 4 illustrate this process. The ultrasonic zero degree longitudinal waveforms are obtained by delivering an ultrasonic transducer T1 as mounted in a centered probe 10 (see FIG. 4) to the elevation within the tube T2 where the support structure S1 is present. The probe is rotated and translated in a helical pitch pattern to scan the length of the tube that encompasses the region where the separation (gap) G1 between the tube outer diameter surface and tube support resides. Ultrasonic signal processing equipment amplifies and digitizes the signal from the transducer and transmits the digitized signal response to a computer for post-processing into a format that is suitable for analysis. The zero degree ultrasonic response contains a number of waveform reflections from the tube wall (outer diameter and inner diameter wall thickness multiples) as shown in the radio frequency (RF) waveform W1 shown in the bottom frame of FIG. 5. The RF waveform W2 that is shown in FIG. 6 contains the same tube wall thickness reflections with an additional, much smaller signal superimposed from the support structure S1. The additional smaller signal is from the separation between the outer diameter surface of the tube and the surface of the support structure (gap signal), which is not easily detected or characterized from the information available in FIG. 6.

The process presented herein allows the clear detection and measurement of the adjacent structure gap signal. The technique subtracts the average of two adjacent (acquired) waveforms W5 and W6 from the (acquired) waveform being processed W2 to reveal (expose) the reflections generated by the gap (post-processing result waveform WR2 that is shown in FIG. 8).

### DESCRIPTION OF THE DRAWINGS

The present invention is described with reference to the accompanying drawings, wherein:

FIG. 1 presents an example of a U-tube steam generator.

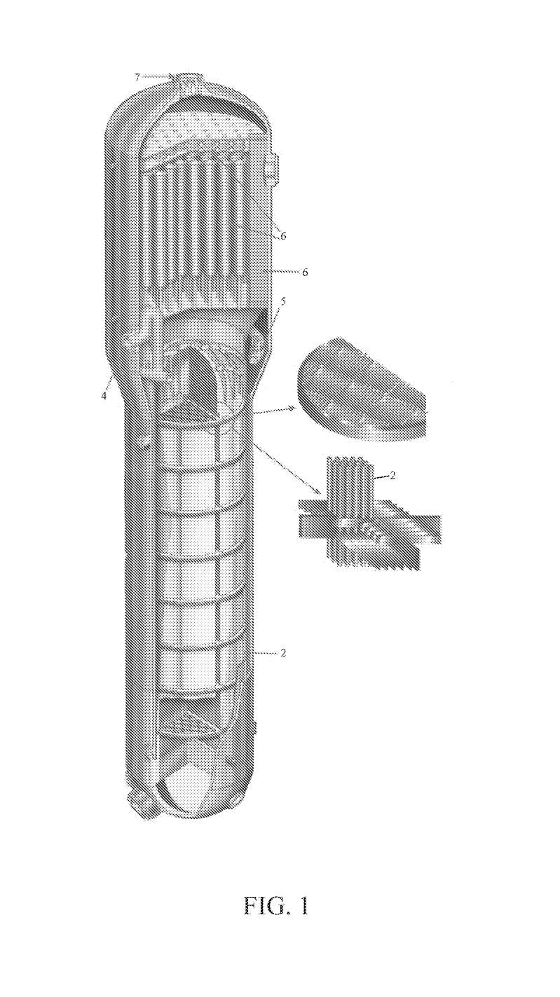

FIG. 2 presents a close-up view of gaps between the tubes and the anti-vibration bars.

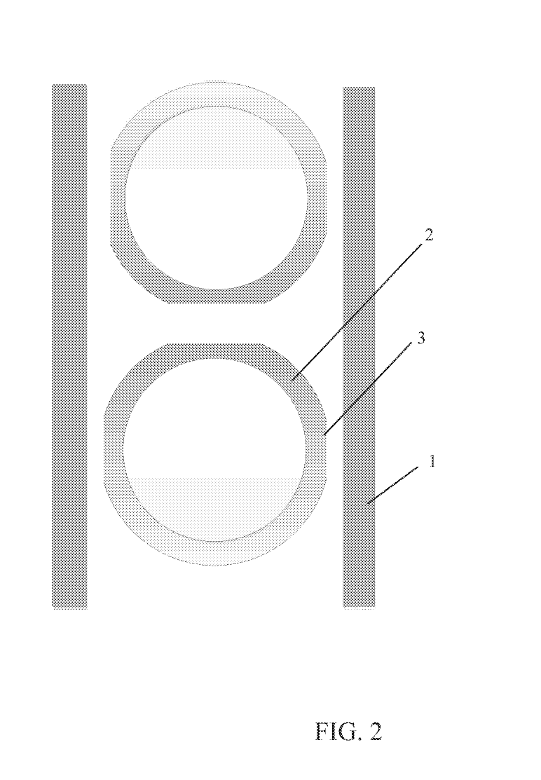

FIG. 3 presents the process of acquiring ultrasonic zero degree longitudinal (thickness) waveforms (W1-W6) by rotating an ultrasonic transducer (T1) within the inner diameter of a tube (T2) with an adjacent support structure (S1) that has a separation (gap) (G1) between the tube outer diameter surface and the surface of the support structure.

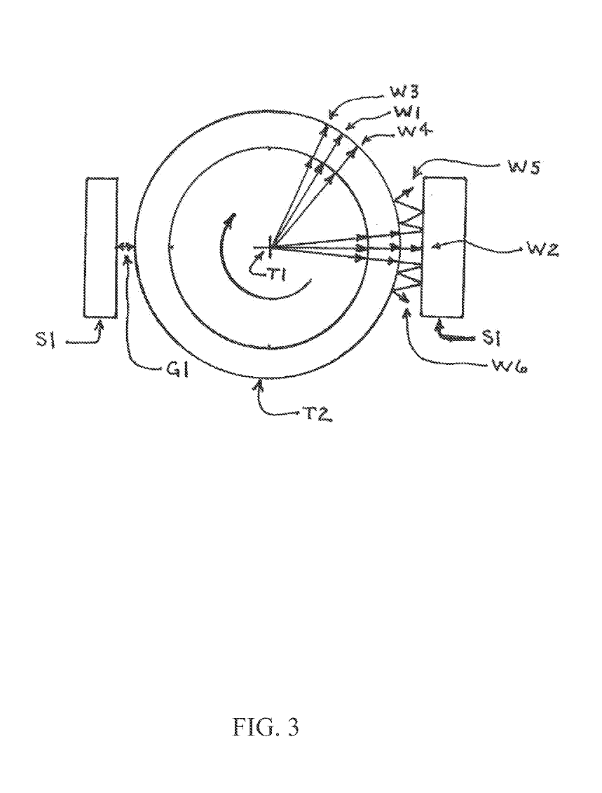

FIG. 4 presents a typical ultrasonic U-bend probe.

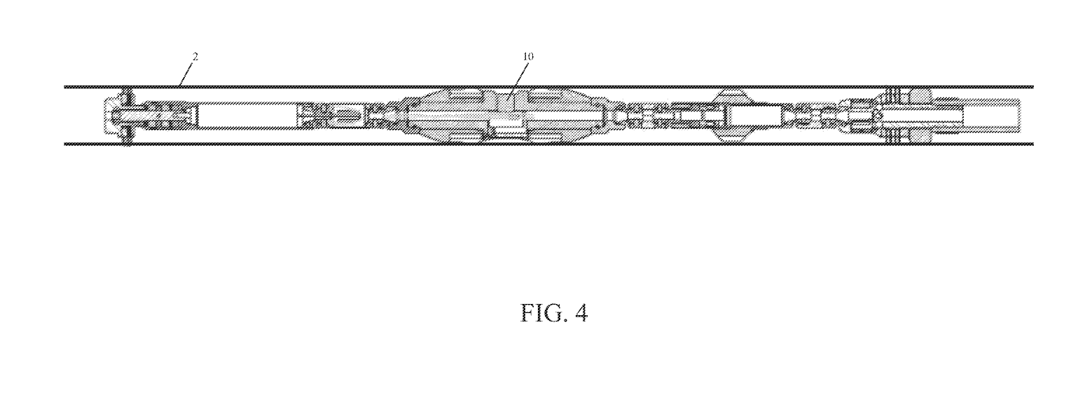

FIG. 5 presents a typical acquired ultrasonic zero degree longitudinal (thickness) waveform.

FIG. 6 presents a typical acquired ultrasonic zero degree longitudinal (thickness) waveform.

FIG. 7 presents the post-processing result waveform (WR1) of the inventive technique wherein the average of two adjacent waveforms W3 and W4 has been subtracted from the waveform W1 shown in FIG. 5.

FIG. 8 presents the result WR2 of the inventive technique wherein the average of two adjacent waveforms W5 and W6 has been subtracted from the waveform W2 shown of FIG. 6.

### DETAILED DESCRIPTION OF THE INVENTION

Known techniques for measuring small spaces between the structural components of a piece of equipment or a system, such as the gap between the steam generator tubing of a pressurized water reactor nuclear power plant and its support structures, which gap may increase due to wear, is typically based on data from a rotating probe that acquires a helical pattern of ultrasonic thickness measurements within a cylindrical tube structure. Typically, approximately 180 thickness waveforms are recorded for each rotation of the probe. However, the method presented herein is not constrained to the probe design, scanning method, or specific geometry.

The inventive technique includes post-processing of the ultrasonic zero degree longitudinal (thickness) waveforms acquired for a typical tube wall thickness examination. The post-processing steps are described herein for each acquired waveform.

Initially, two additional acquired waveforms to be averaged are selected to predict the thickness waveform for the waveform being processed. Logically this selection process would involve selecting a waveform on each side of the waveform being processed at roughly equal circumferential (radial) spacing such that the average of the two selected waveforms would be expected to be equivalent to (resemble the portion comprising the wall thickness reflections) the waveform being processed.

Using the first transition of the front surface reflection from the negative peak to the positive peak (zero thickness point) of each of the selected waveforms to be averaged, the two waveforms are aligned using a best fit (least squares technique) of the digitized data points between the transition point and some quantity of data points beyond. For example, the data points between the transition and the second back surface reflection can be used, but the method does not require a specific quantity of data points, only that the quantity of data points be sufficient to perform a statistically relevant least squares evaluation.

Once the best fit alignment has been determined, the two selected waveforms are averaged to produce the waveform to be subtracted from the waveform being processed to reveal any reflections other than the reflections associated with the tube wall thickness response.

Since all digitization processes have variance equal to a single digitization interval, the averaged waveform and the waveform being processed may require expansion to the next higher level of digitization prior to performing the subtraction. For example, this may be the case for the application of this technique within the U-bend region of the steam generator. The constantly changing probe motion (as observed in the water path distance) along with the digitization variance can result in the technique either working well or failing to suppress (remove) the amplitudes of the wall thickness reflections during the subtraction process.

Digitization equipment typically has a digitization rate of approximately 100 MHz (data point interval spacing of 10 nanoseconds). While this is sufficient for processing data from a well centered probe in the straight sections of the tube, it may not be sufficient for probes with wobble (pitch and yaw variances greater than 0.001 inch) or probes operating in the U-bend region. To improve the alignment of the averaged waveform and the waveform being processed prior to the subtraction, each waveform can be expanded to the equivalent of a 200 MHz digitization rate (data point interval spacing of 5 nanoseconds). Although a preferred expansion method used by the technique is piecewise linear interpolation, any expansion transform that yields a reasonable replication of the waveform as would have been generated at a 200 MHz digitization rate will be understood as equivalent. The appropriateness of the expansion method is determined by the thickness reflection residual after the subtraction of the two waveforms. Generally, a three to one (3:1) or better signal to noise ratio is considered acceptable for ultrasonic signal analysis. Currently, testing within the U-bend region with multiple probe designs indicates that the use of the piecewise linear interpolation method to expand the two waveforms is sufficient for eliminating the unwanted wall thickness reflections and providing better than a 3:1 signal to noise ratio for the exposed reflections from the gap (separation between the outer diameter surface of the tube and the adjacent support structure).

Once the averaged waveform and the waveform being processed have been expanded to an equivalent 200 MHz digitization rate, the two waveforms can be aligned using the least squares method and the averaged waveform can then be subtracted from the waveform being processed. To preserve the front surface reflection, the subtraction process preferably proceeds from the transition data point to the end of the waveform.

The resultant waveform generated from the subtraction is reduced to its 100 MHz equivalent by maintaining every-other data point. This waveform is then stored in a process data channel at the same coordinate location as that of the waveform being processed. The content of the processed data channel consists of waveforms with just the front surface reflection or waveforms with a front surface reflection and reflections from the gap.

For a given waveform with a gap signal response, the gap distance is determined by measuring the delta depth (time of flight) between the leading gap reflection and the expected (as measured from the thickness waveform) depth of the first back surface reflection. Since the separation between the tube outer diameter surface and the support structure is liquid filled, the measured distance must be corrected by the ratio of the sound velocities of the tube material (Inconel 690 in the example application) and the liquid (water in the example application). For the example application, the ratio is (0.058/0.233) or 0.25. For a 100 MHz digitization device, this yields a gap measurement resolution of approximately 0.0003 inch, which is sufficient to obtain accurate gap measurements of 0.001 inch.

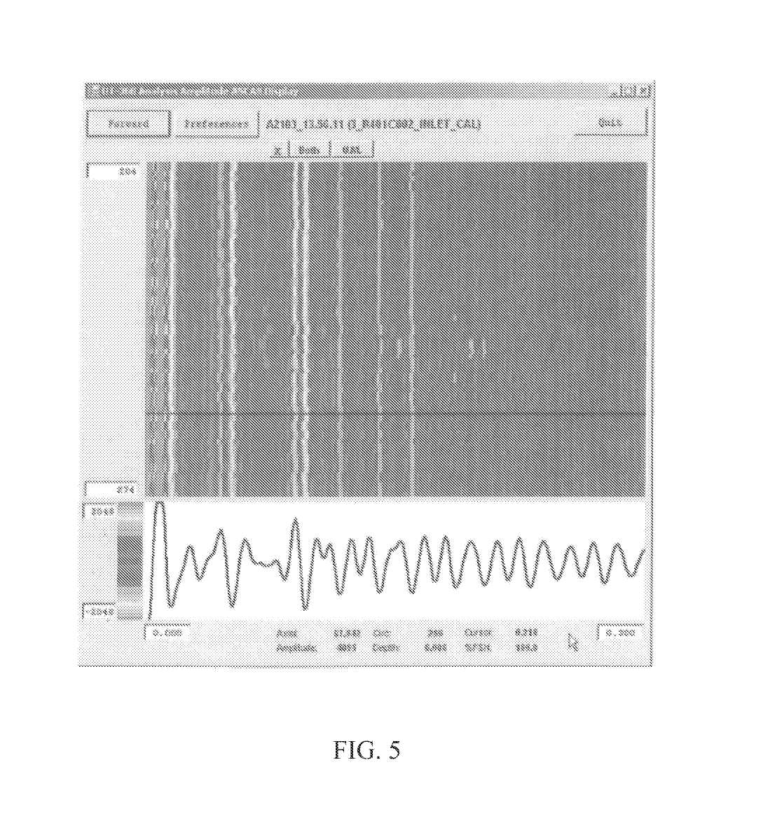

The following example is provided to aid in the understanding technique. FIG. 5 presents a typical ultrasonic zero degree longitudinal (thickness) waveform. This waveform does not have reflections from the gap W1.

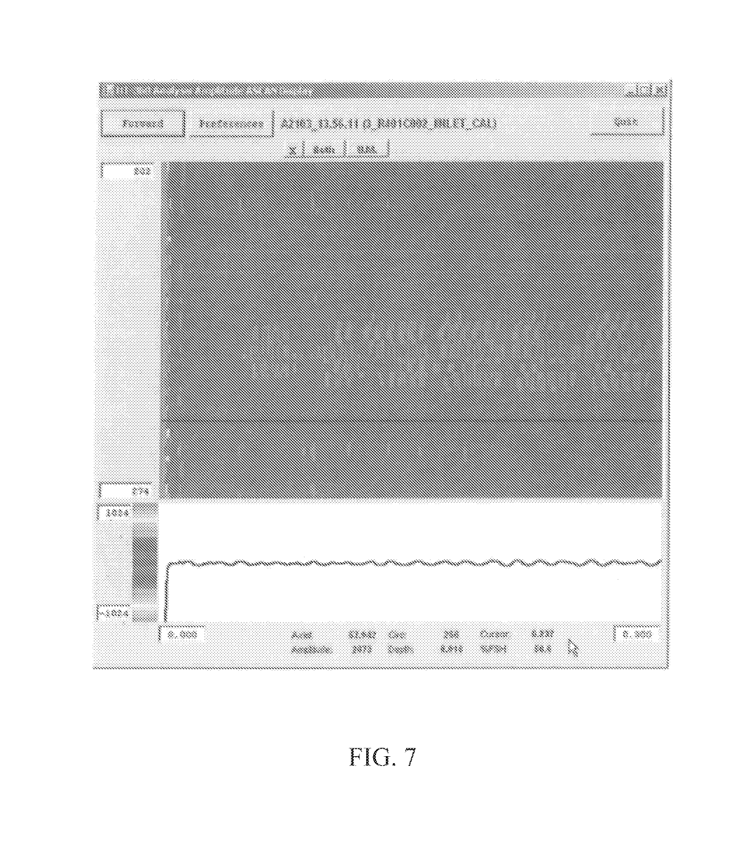

FIG. 7 presents the result WR1 of the technique wherein the average of two adjacent waveforms W3 and W4 has been subtracted from the waveform W1 shown in FIG. 5 (the waveform being processed). WR1=W1−((W3+W4)/2). This waveform does not have reflections from the gap. The small amount of residual from the subtraction process (signal ripple) meets the desired signal to noise ratio.

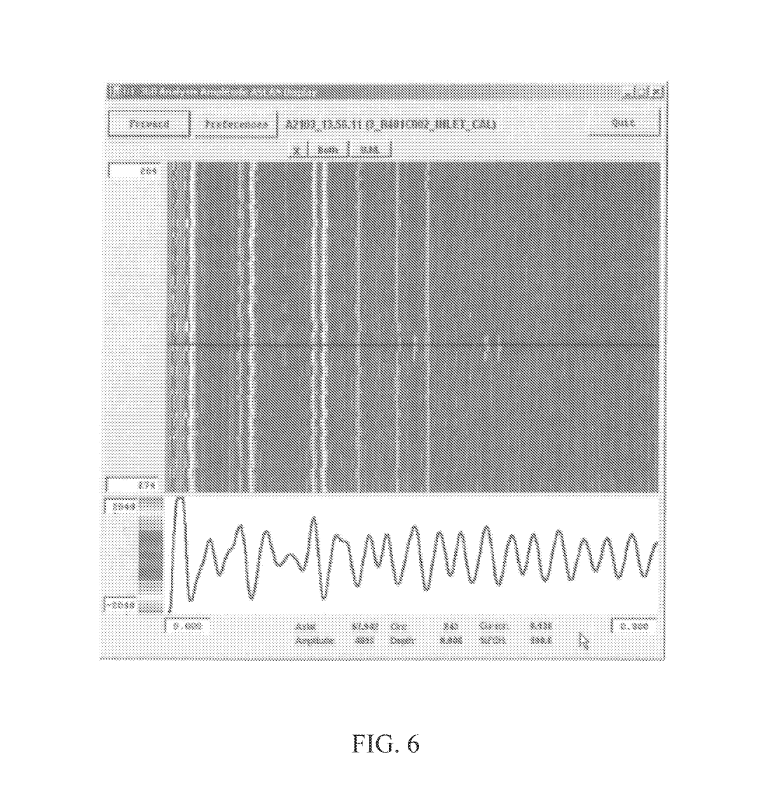

FIG. 6 presents a typical ultrasonic zero degree longitudinal (thickness) waveform. This waveform does have reflections from the gap W2.

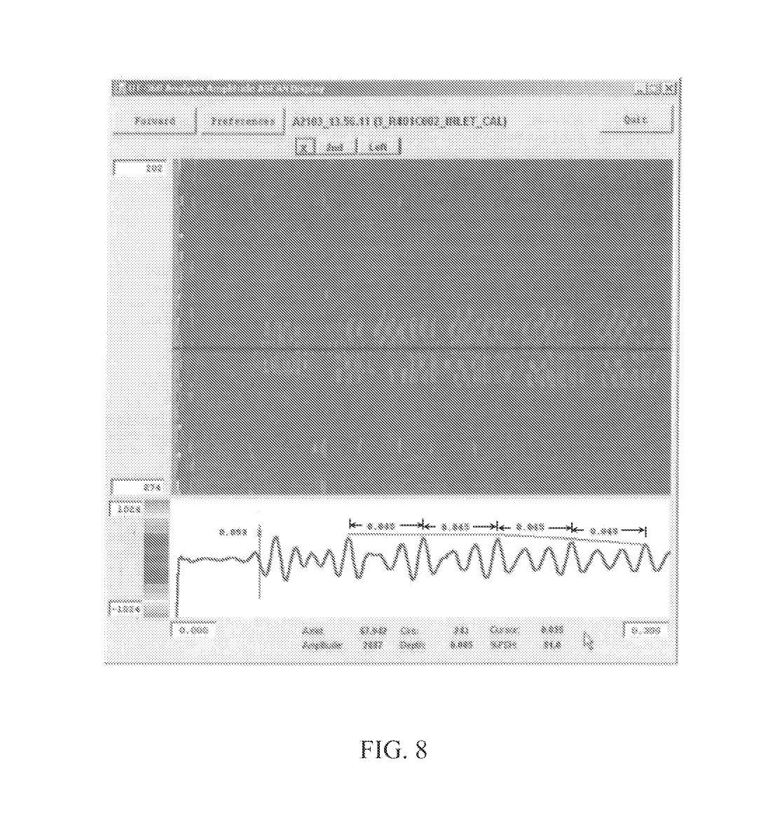

FIG. 8 presents the result WR2 of the technique wherein the average of two adjacent waveforms W5 and W6 has been subtracted from the waveform W2 shown in FIG. 6 (the waveform being processed). WR2=W2−((W5+W6)/2). Gap measurements are determined based on the average time between analyst selected local maximum peaks within the waveform resulting from echoes between the tube and the AVB as shown. This waveform does have reflections from the gap. The signal to noise ratio comparison of the signal ripple in FIG. 7) is excellent. The recurring reflections after the initial gap reflection are successive reflections within the tube wall and consequently are a measure of the tube wall thickness at the location of the gap measurement. The difference of the gap signal depth (0.053 inch) and the wall thickness value (0.045 inch) times the ratio of the sound velocities (0.25) is the measured gap (separation distance between the outer diameter surface of the tube and the support structure), (0.053−0.045)×0.25)=0.002 inch gap.

Manual selection of the FIG. 8 waveform peaks to determine the echo-time and correspondingly calculate the gap may also be enhanced and automated using various mathematical treatments including correlation functions, wavelet transforms, and Fourier transforms. One possible approach would be to isolate the initial pulse waveform (Fₜ) then perform a cross-correlation treatment (*) with the entire UT signal (Gₜ) to produce a point-by-point cross-correlation argument (argₜ). The time delay (τ) from the initial waveform to each data point can then be assessed and the best-fit time delay is arg max of the treatment. This is defined by:

τ_{delay}=argₜ max(F*G)(t))

The described technique is effective for any transducer frequency, element diameter, and composition wherein the waveform acquired from the transducer contains reflections from the gap in addition to reflections from the tube wall thickness.

If digitization rate of the ultrasonic instrument is not sufficient to reduce the amplitude of the thickness reflection residual (waveform subtraction result) to an acceptable signal to noise ratio, the expansion of the waveforms to a higher digitization rate by the technique can be used to obtain an acceptable signal to noise ratio. It is understood that expansion of the two adjacent waveforms to be averaged can also be used to further reduce the amplitude of the thickness reflection residual. It is also understood that any expansion method that reduces the thickness reflection residual (waveform subtraction result) to the desired signal to noise ratio is acceptable.

The selection process for the two waveforms to be averaged is not essential. Any selection process can be used as long as the resultant averaged waveform sufficiently predicts (replicates) the expected thickness waveform of the waveform to be used in the subtraction (waveform being processed). Waveforms with symmetric separations of two, three, four, and five waveforms from the waveform being processed have produced acceptable signal to noise results for gaps measured in the U-bend region as well as in the straight lengths.

The method presented may be expanded to any combination of waveforms, scan patterns, transducer designs, frequencies or probe designs to highlight any desired signal response. For example, the technique could also be used to detect the distance between adjacent tubes (tube-to-tube spacing) with the proper selection of transducer design, frequency and waveform responses.

The inventive technique allows a single transducer to acquire the waveforms to be processed. The acquired waveforms can be used to measure the tube wall thickness and the processed waveforms can be used to measure the separation between the outer diameter surface of the tube and the adjacent support structure (gap). The depth of view of angle beam gap measuring techniques are typically a function of half of the diameter of the receiving (catch) transducer. The depth of view for zero degree longitudinal wave wall thickness examination is a function of the signal strength of the returning reflected energy from the support structure. With the optimal selection of transducer frequency, element diameter, and composition, viewing depths in excess of 0.25 inch have been demonstrated.

The single transducer (zero degree) approach allows for a minimal probe length and improved access to smaller radius U-bends. Essentially, the portion of the probe that contains the transducer should not be the limiting factor to accessing most U-bend regions of interest.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

1. A method of measuring a gap between a tube outer diameter and a support structure for the tube, comprising:
providing an ultrasonic measurement instrument including a transducer;
performing a zero degree longitudinal wave wall thickness examination of the tube with the instrument;
collecting data from the zero degree longitudinal wave wall thickness examination; and
processing the data to remove reflections from the tube to reveal reflections from a gap between the tube and the support structure.

2. The method of claim 1, further comprising calculating a separation distance between an outer diameter surface of the tube and the support structure from the processed data.

3. The method of claim 2, wherein said calculating includes performing a mathematical treatment of the processed data to calculate said separation distance.

4. The method of claim 1, wherein said collecting data includes collecting an initial amount of data, and further comprising expanding the collected data prior to the processing to contain approximately 1.5 to 2.5 times the initial amount of data.

5. The method of claim 4, wherein the expanding includes linear interpolation.

6. The method of claim 1, wherein said collecting data includes acquiring waveforms and said processing the data includes processing the waveforms.

7. The method of claim 6, wherein said processing the data comprises subtracting a first waveform predicting a thickness waveform of the tube from a second waveform being processed.

8. The method of claim 7, wherein said processing the data comprises aligning the first waveform predicting the thickness waveform and the second waveform being processed before subtraction.

9. The method of claim 8, wherein said aligning comprises using a best fit technique.

10. The method of claim 9, wherein said best fit technique comprises a least square technique.

11. The method of claim 7, wherein the first waveform predicting the thickness waveform is an average waveform between two waveforms selected from the acquired waveforms.

12. The method of claim 11, wherein the two selected waveforms comprise a waveform on each side of the second waveform being processed.

13. The method of claim 12, wherein the two selected waveforms have symmetric separations with the second waveform being processed.

14. The method of claim 11, further comprising aligning the two selected waveforms before averaging the two selected waveforms.

15. The method of claim 14, wherein said aligning comprises using a best fit technique.

16. The method of claim 15, wherein said best fit technique comprises a least square technique.

17. The method of claim 2, wherein said calculating comprises determining the separation distance by measuring a delta depth between a leading gap reflection and an expected depth of a first back surface reflection.

18. The method of claim 17, wherein said calculating comprises correcting the separation distance by a ratio of sound velocities of the tube material and a fluid in the separation between the tube outer diameter and the support structure.
